(19) United States
(12) Patent Application Publication
(10) Pub. No.: US 2010/0179281 A1
(43) Pub. Date: Jul. 15, 2010

(54) COATING COMPOSITIONS COMPRISING ORGANOFUNCTIONAL POLYSILOXANE POLYMERS, AND USE THEREOF

(75) Inventor: Sigurd Nilsen, Tonsberg (NO)

Correspondence Address: GARDNER GROFF GREENWALD & VILLANUEVA. PC, 2018 POWERS FERRY ROAD, SUITE 800, ATLANTA, GA, 30339, US

(73) Assignee: JOTUN A/S, Sandefjord (NO)

(21) Appl. No.: 12/666,922

(22) PCT Filed: Jul. 1, 2008
(86) PCT No.: PCT/EP08/58461

§ 371 Date: Mar. 31, 2010

(30) Foreign Application Priority Data
Jul. 2, 2007 (NO) 20073388

(51) Int. Cl. C08L 83/04

(52) U.S. Cl. 524/588

(57) ABSTRACT

The present invention relates to a coating composition comprising an organofunctional polysiloxane polymer as a binding resin, obtaining the polymeric structure as part of a curing mechanism or a combination thereof. The main advantage of the invention is that it enables the formation of a flexible inorganic polymeric structure that is more UV-light, heat and oxidation resistant than a coating comprising a large percentage of a carbon based organic polymer.

The present invention relates to a coating composition comprising an organofunctional polysiloxane polymer as a binding resin obtaining the polymeric structure as part of a curing mechanism or a combination thereof.

The main advantage of the invention is that it enables the formation of a flexible inorganic polymeric structure that is more UV-light, heat and oxidation resistant than a coating comprising a large percentage of a carbon based organic polymer.

Polysiloxane polymers are in general recognized by a good heat, light and oxidation resistance, but when applied as a three-dimensional cross linked network of a certain volume, they tend to be brittle. With prior art technology this problem is solved by mixing the polysiloxane with a more flexible organic polymer. The organic polymer is on the other hand generally less heat, UV-light and oxidation resistant and the resulting film will be a compromise between the two sets of properties.

It is now surprisingly found that by making a flexible siloxane cross linked network, the amount of organic modification can be reduced, and the resulting film will be recognized by a good heat, light and oxidation resistance.

Polysiloxane resins and coatings based on this technology have been in the market for some time. The technology is primarily utilized in protective coatings; mainly on epoxy primed steel substrates. The advantage of the technology is that it is very resistant to UV-light, heat and oxidation.

The curing mechanism of siloxane coatings is a two step mechanism. First, a hydrolysable group attached to the silicon atom is split off in a reaction with water, to form a silanol. The silanol then react with another silanol in a condensation reaction to form a silicon-oxygen-silicon chemical bonding which is characteristic for siloxane coatings. The hydrolysable group can be a halogen, ketoxime or acetoxy groups, but the most common is alkoxy group.

The description of the current invention will reveal that a result of the implementation of tri- and tetraalkoxy functional silanes is that when used in resins or coating compositions, coatings will be brittle or turn brittle after some time. Prior art thumb of rule says that a polysiloxane coating must be modified by approximately 30 wt % organic binder relative to the siloxane content in order to retain a flexible cured polysiloxane coating.

U.S. Pat. No. 4,308,371 describes a method of producing organopolysiloxanes by using organoalkoxysilanes and/or organoalkoxysiloxanes as starting materials. Alkoxyfunctional silanes used are a mixture of di-, tri- or tetraalkoxysilanes with formula: R¹ₐSi(OR²)₄₋ₐ, where a is 0, 1 or 2. This represents the standard polysiloxane polymeric structures applied in coatings and other material science. The resulting to polymer is an alkoxyfunctional polysiloxane that can be cured at room temperature with typically amino functional trialkoxy silanes. The drawback is that when utilizing tri- and tetraalkoxy functional silanes, coatings will be brittle due to build up of internal stress in the polymeric structure over time. In order to overcome this, a modification of at least 30% of organic polymer is necessary to absorb the tension in the polymeric matrix.

EP 691 362 describes a method of producing organopolysiloxanes by using organoalkoxysilanes and/or organoalkoxysiloxanes as starting materials. The organoalkoxysilanes can be methyl trimethoxysilane or tetramethoxysilane, and the invention is different from U.S. Pat. No. 4,308,371, mainly in that the alkoxy groups linked to the same silicon atom are of different reactivity. The advantage relative to that of U.S. Pat. No. 4,308,371 is that the polymeric structure can be controlled in a better way with this technology. The drawback is however similar to that of U.S. Pat. No. 4,308,371 due to the fact that both tri- and tetra alkoxyfunctional silanes are applied, and that this in turn will give build up of internal stress in the polymeric structure over time.

US 2004/0077757 describe a coating composition produced by using two tetra-, tri- and dialkoxyfunctional organosilanes and an organic block copolymer as starting materials. The coating will either be brittle when organic modification is kept at a low level, due to the similar starting materials and curing process as U.S. Pat. No. 4,308,371. If level of organic modification is increased, the coating will be less resistant to UV-rays, heat and oxidation.

The molecular modelling studies prior to the current invention revealed that in a structure of curing trialkoxy functional siloxanes, the internal strain would build up fast as the distance between silicon-oxygen bindings are too small for the expanding silicon-oxygen grid to obtain a low tension structure.

Another disclosure was that as the silicon-oxygen grid expands, the possibility of an alkoxy group being left unreacted increases as the grid expands. The molecular space left open is so small that ethoxy and possibly also methoxy groups will be trapped in the structure.

The grid is however not as tight as it would prevent water from moving as an interstitial molecule in the silicon-oxygen network. The alkoxy curing mechanism is initiated by water, and when present in a cured coating with unreacted alkoxy groups, this initiates curing with a resulting split off of an alcohol group. This reaction will drastically increase the internal tension of the silicon-oxygen grid of the cured coating.

As the magnitude of tension due to internal stress exceeds the cohesion force in the paint film, small fracture failures will appear. This again will open the way for new unreacted alkoxy groups to split off and further increase the coating film tension.

The prior art thumb of rule of 30 wt % organic binder modification will absorb some of the internal stress build up, and for a period of time it will prevent the small fractures from open the way for new unreacted alkoxy groups to split off, but with time, the organic binder will turn brittle, and can no longer absorb the tension of the curing mechanism.

The prior art explanation of polysiloxane brittleness is that the glass like structure can never be flexible. However the molecular modelling unexpectedly showed that at a similar cross linking density, also carbon based grids would have tension and be brittle.

The current invention represents a new way of dealing with alkoxy curing, in the way that it presents a method for preventing the structure from being brittle rather absorbing brittleness as it develops.

The current invention will, by the use of organosilanes with two hydrolysable groups, make silicon-oxygen linear molecule with organic side chains. By applying organofunctional silanes, a network can develop a grid that has organic crosslinks.

The current invention can also be modified with organosilanes with three hydrolysable groups. The organosilanes with three hydrolysable groups open the possibility of a three dimensional silicon-oxygen grid. By selecting the amount of organosilanes with three hydrolysable groups the grid openings can be adjusted to allow for the hydrolysable groups to cure without the rapid build up of internal tension, and without trapping unreacted hydrolysable groups in the expanding grid.

By applying organosilanes with one hydrolysable group, or a high molecular weight alcohol, the rest of the hydrolysable siloxanes can be reacted to leave virtually no hydrolysable functionality in the polymeric structure.

### Polymer

The present invention provides a polymer having an inorganic backbone and organic and organofunctional side groups. The polymer is obtained by hydrolysis and condensation polymerization of organosilanes with two hydrolysable groups or a mixture of organosilanes with two hydrolysable groups, and organosilanes with three hydrolysable groups, with optional organosilanes with one hydrolysable group that can be used to regulate polymeric chain growth.

The organosilanes with two hydrolysable groups can be represented by the chemical formula:

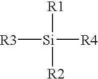

wherein R¹ and R² are independently selected from the group consisting of alkyl, aryl, reactive glycidoxy, amino, mercapto, vinyl, isocyanate or methacrylate groups having up to 20 carbon atoms, R3 and R4 are halogen or alkoxy, ketoxime or acetoxy groups having up to six carbon atoms.

Examples of difunctional silanes with corresponding CAS numbers are: AMINOPROPYLMETHYLDIETHOXYSILANE, CAS:3179-76-8 AMINOETHYLAMINOPROPYLMETHYLDIMETHOXYSILANE, CAS:3069-29-2 GLYCIDOXYPROPYLMETHYLDIETHOXYSILANE, CAS:2897-60-1 ISOCYANATOMETHYLMETHYLDIMETHOXYSILANE, CAS:406679-89-8 MERCAPTOPROPYLMETHYLDIMETHOXYSILANE, CAS:31001-77-1 VINYLDIMETHOXYMETHYLSILANE, CAS:16753-62-1 METHACRYLOXYPROPYLMETHYLDIMETHOXYSILANE, CAS:14513-34-9 DIMETHYLDIETHOXYSILANE, CAS:78-62-6

The organosilanes with three hydrolysable groups can be represented by the chemical formula:

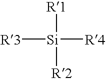

wherein R′1 is independently selected from the group consisting of alkyl, aryl, reactive glycidoxy, amino, mercapto, vinyl, isocyanate or methacrylate groups having up to 20 carbon atoms, R′2, R′3 and R′4 are halogen or alkoxy, ketoxime or acetoxy groups having up to six carbon atoms.

Examples of trifunctional silanes with corresponding CAS numbers are: AMINOPROPYLTRIETHOXYSILANE, CAS:919-30-2 AMINOPROPYLTRIMETHOXYSILANE, CAS:13822-56-5 GLYCIDOXYPROPYLTRIMETHOXYSILANE, CAS:2530-83-8 ISOCYANATOPROPYLTRIMETHOXYSILANE, CAS:15396-00-6 MERCAPTOPROPYLTRIMETHOXYSILANE, CAS:4420-74-0 VINYLTRIMETHOXYSILANE, CAS:2768-02-7 METHACRYLOXYPROPYLTRIMETHOXYSILANE, CAS:2530-85-0

The organosilanes with one hydrolysable group can be represented by the chemical formula:

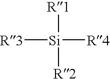

wherein R″1, R″2 and R″3 are independently selected from the group consisting of alkyl, aryl, reactive glycidoxy, amino, mercapto, vinyl, isocyanate or methacrylate groups having up to 20 carbon atoms, R″4 is halogen or alkoxy, ketoxime or acetoxy groups having up to six carbon atoms.

Example of monofunctional silane with corresponding CAS number is: TRIMETHYLETHOXYSILANE, CAS:1825-62-3

Halogen, ketoxime and acetoxy groups are regarded as equivalents to alkoxy groups in that they will be splinted off in the hydrolysis/condensation mechanism of polymerization. Silanes with alkoxy groups are by far the most commercially available, and therefore the preferred functionality in the polymerization reaction.

The main advantage with this mix of tri-, di- and optional monofunctional alkoxy is functionality is that chain length, branching and functionality can be adjusted to wanted specifications, by selection of mixing ratios and polymerization conditions.

In addition, the present invention can drastically reduce the quantity of unreacted alkoxy groups associated with the commercially available analogue products, SILRES HP 1000 and SILRES HP 2000 (both ex. Wacker Chemie AG) that are based on the prior art technology.

### Coating Composition

### Binders by Prepolymerisation

With a polymer obtained by the present invention, a coating can be made that utilizes the said polymer as a binding resin.

Depending on chosen functionality, a coating can be made that can be cured with a chemical processes involving the said functionality.

A coating can be made that utilizes the said polymer, with reactive epoxy groups, as a binding resin. The said resin can be cross linked with any reactive amino, mercaptan or carboxyl group containing component at room temperature to form an ambient temperature curable coating. In addition, the said resin can be cross linked with a reactive epoxy or hydroxyl group containing component at elevated temperatures to form a high temperature cured coating.

A coating can be made that utilizes the said polymer, with reactive amino groups, as a binding resin. The said resin can be cross linked with a reactive epoxy group containing component at room temperature to form an ambient temperature cured coating.

A coating can be made that utilizes the said polymer, with reactive mercaptan groups, as a binding resin. The said resin can be cross linked with a reactive epoxy group containing component at room temperature to form an ambient temperature cured coating.

A coating can be made that utilizes the said polymer, with reactive isocyanate groups, as a binding resin. The said resin can be cross linked with a reactive hydroxy group containing component at room temperature to form an ambient temperature cured coating.

A coating can be made that utilizes the said polymer, with reactive vinyl groups, as a binding resin. The said resin can be cross linked with a reactive vinyl or methacrylate group containing component in the presence of a free radical to form a free radical cured coating. The said resin can also be cross linked with a reactive vinyl or methacrylate group containing component when exposed to UV-light to form a UV-light cured coating.

A coating can be made that utilizes the said polymer, with reactive methacrylate groups, as a binding resin. The said resin can be cross linked with a reactive vinyl or methacrylate group containing component in the presence of a free radical to form a free radical cured coating. The said resin can also be cross linked with a reactive vinyl or methacrylate group containing component when exposed to UV-light to form a UV-light cured coating.

In addition a coating can be made that utilizes the said polymer, with primary amino groups made inactive by a reversible reaction involving a ketone, as a binding resin. The said resin can be blended with a reactive epoxy group containing component to form an ambient temperature moisture curable coating. A ketone will react with the reactive primary amine to form a ketimine. The ketimine formation reaction splits off water in a reversible process. By removing water from the said resin-ketimine, reactive epoxy components can be blended without cross linking as long as water is not present. The curing process of the resin becomes a two step mechanism, where the first step is the reaction where water and ketimine forms a primary amino group and a ketone, and the second step is an epoxy-amine curing mechanism.

Polymers obtained by the present invention can be prepared as relatively low viscosity liquids that enable coating compositions with a reduced solvent content. Compared to alkoxy functional silanes and siloxanes, only marginal condensation of alcohols is released to the atmosphere when the polymers of the present invention are cured.

### Binders by “Cold Blend” of Components

The polymeric structure of the present invention can also be obtained as part of a curing mechanism in a coating, by a so called “cold blend”. A “cold blend” should be understood as applying polymeric building blocks in the coating composition rather than adding a polymer that is already polymerized in a chemical engineering reactor when added to the coating composition.

The method involves a coating composition comprising a reactive polysiloxane and an organosilane with two hydrolysable groups and an organosilane with three hydrolysable groups. An organosilane with three hydrolysable groups, and a non reactive polysiloxane can be added to adjust the said coatings properties.

The polysiloxane of choice for the method of blending in the present invention can be described by the chemical formula:

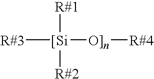

wherein for each n, R#1 and R#2 are independently selected from the group consisting of halogen, alkyl, aryl, reactive glycidoxy, amino, mercapto, vinyl, isocyanate or methacrylate groups having up to 20 carbon atoms and OSi(OR#5)₃ groups, wherein each R#5 independently has the same meaning as R#1 and R#2, R#3 and R#4 are either alkyl, aryl or hydrogen.

The number n should be chosen so that the molecular weight of the polymer is in the region of 400 to 2000. This ensures that the cured polymer is not brittle and that viscosity is in a convenient range for high solids coating composition.

Examples of polysiloxanes that can be used in the composition according to the present invention include: From Dow Corning Inc.: DC 3037 and DC 3074. From Wacker Chemie AG: SILRES SY231, SILRES SY 550, SILRES HP1000, SILRES HP2000 and SILRES MSE 100. From Tego Chemie Service: SILIKOPON EF.

In addition a prepolymerised resin obtained by the present invention can be used.

A non reactive polysiloxane can be added to improve the initial gloss of the cured coating. Examples of non reactive polysiloxanes that can be used in the composition according to the present invention include:

From Tego Chemie Service: SILIKOPHEN P 50/X and SILIKOPHEN P 80/X. From Wacker Chemie AG: SILRES REN50 and SILRES REN80.

A “cold blend” coating composition according to the present invention can be made either as a one or a two component coating. For the case of a two component solution, active groups that can react must be packed separately, and the blending of the components must take place prior to application.

For the one component alternative, one of the active groups that can react must be blocked, which can be done with primary amino groups. The ketimine formation are described earlier in this patent.

As for the prepolymerised resin that can form a ketimine, the possibility is also present for the ketimine formation of a primary amino functional silane that is also alkoxy functional. The problem of blocking amino groups is that a water molecule is split off during the blocking, and that the alkoxy functionality will react with water resulting in a possible unstable blend of components.

The curing mechanism of the hydrolysable groups are dependent on the presence of water, in addition a proton donor is required to speed up the reaction. A preferred proton donor is a primary or secondary amine. In most cases the amine is chosen to be an aminosilane. The aminosilane then acts as a catalyst and the reactive amino groups are left unreacted. This fact makes resins with epoxy groups popular as organic modification for siloxane coatings. In traditional coating compositions, good practise is to balance the amount of epoxy and amine functionality so that theoretically no groups are left unreacted in the cured film.

With the present invention the crosslink density can be adjusted to match wanted coating properties without utilizing the amino functionality of the aminosilanes. By leaving the amino functionality unreacted, the whole polymeric network will consist of inorganic silicon-oxygen backbone. The said coating will be moisture curing, and can be packed as a one component coating, or it can be additionally cured with an epoxyfunctional hardener.

The coating composition disclosed by the present invention can be a clear coat without is pigmentation, or it can be pigmented with coloured pigments and fillers.

The coating composition disclosed by the present invention can be made with additives to modify production, application and cured coating properties.

The coating composition disclosed by the present invention can have additional organic binders to adjust properties.

The said organic binder can be unreactive, have an amino hardener, a carboxyl functional acrylic or a mixture thereof present to adjust performance.

The said organic binder can also be unreactive, epoxy type, an epoxy functional acrylic or a mixture thereof present to adjust performance.

The said organic binder can also be unreactive, vinyl, acrylic or a mixture thereof present to adjust performance.

The coating composition disclosed by the present invention can be made with solvents to facilitate production and application. The solvents can be either reactive or unreactive.

Of the reactive solvents, any solvents with reactive groups can be chosen. Solvents should not be chosen that will react irreversible with the functional groups of the said resin. Alcohols or alkoxy functional solvents are not recommended for isocyanate-functional resins as they can react with the isocyanate groups.

Epoxy functional resins should not be stored with protic solvents such as alcohols, as it would catalyze self polymerization. An aprotic solvent such as butyl acetate could in theory prevent self polymerization of the resin.

One preferred choice of reactive diluents is the corresponding dialkoxy functional silane or the trialkoxy functional silane that were used in the polymerization of the present invention with given functionality, or a combination of the said alkoxy functional silanes.

In the case of the coating being moisture curable, the invention also relates to the use of a partly incompatible non polar solvent with lower density than the binding resin to is increase storage stability and pot life of the coating. The partly incompatible non polar solvent will blend with the rest of the coating composition when blended, but when left still, a thin layer of solvent will appear on top of the wet coating due to the lower density. The thin film of solvent will separate the paint from the headspace, and as the solvent is selected to be non polar, water from the headspace will be hindered from being absorbed by the wet coating, as water generally do not blend with non polar solvents.

The solvents will evaporate after application, and water from the atmosphere can be absorbed into the coating.

Solvents that can be used are straight, branched and cyclic hydrocarbons. Preferred hydrocarbons have few double or triple carbon-carbon bonds. Examples are n-hexane and higher temperature boiling straight chained alkanes. Higher boiling hydrocarbons are generally less compatible with both water and coating, but the generally slower evaporation rates increase the drying time of the applied coating.

Examples of partly incompatible non polar solvents are n-hexane, cyclohexane aromatic and low-aromatic white spirits.

Health, safety and environmental considerations should also be taken into account when selecting the solvents, and selecting solvents that have a flashpoint above storing and application temperature will increase the safety of handling.

The main advantage of the invention is that it enables the formation of a flexible inorganic polymeric structure that is more UV-light, solvent and oxidation resistant than a carbon based organic polymer.

The solids content of a coating composition with a polymer obtained according to the present invention enables solids content higher than 60% by weight, and volatile organic content (VOC) of less than 420 grams per litre of organic solvent.

By adjusting the ratio of components in the polymer, glass transition temperatures (Tg) can be adjusted to fit the wanted specification. As a rule, a high concentration of trialkoxy silanes gives a higher Tg, which gives a harder, but less flexible coating.

A harder coating has better scratch resistance, but will in general be more brittle.

The Tg of cured film should be chosen to be higher than the temperature of the environment it will be exposed to, but an upper limit should be established to ensure flexibility of the coating.

If organic modification is included, the Tg of the organic modification should be similar to that of the polysiloxane. This will ensure a more homogenous film when exposed to thermal and mechanical stress.

A coating according to the present invention can be used as a protective coating for the protection of the surface of steel or other metal substrates. The high chemical, oxidation and UV-light resistance makes it suitable as a topcoat applied on top of rust preventing coatings.

A coating according to the present invention can be also be used as a protective coating for the protection of the surface of other substrates such as wood, plastics and concrete, due to the possibility of formulating coatings with high flexibility, and adhesion to various substrates.

A coating according to the present invention can be used as a decorative coating, due to the possibility of formulating coatings with high gloss, and a smooth surface.

A coating according to the present invention can be used in maintenance, marine, construction, architectural, aircraft and product finishing markets.

A coating according to the present invention can be used as an antigrafitti coating, due to the possibility of formulating coatings with high surface tension, and a hard scratch resistant surface.

A coating according to the present invention can be used as a marine antifouling agent, due to the possibility of formulating coatings with high surface tension, and a hard scratch resistant surface, that will prevent fouling from attaching to the coated surface.

### EXAMPLES

The following examples are given to further illustrate the invention Examples related to the polymerization.

Polymers that are made

TABLE 1
Amino functional polysiloxanes prepared according to the present invention

| | | 1 | 2 | 3 | 4 | 5 | 6 |
|---|---|---|---|---|---|---|---|
| | CAS N. | [g] | [g] | [g] | [g] | [g] | [g] |
| Dialkoxy functional silanes | | | | | | | |
| AMINOPROPYLMETHYLDIETHOXYSILANE | 3179-76-8 | | | | | 30 | 60 |
| AMINOETHYLAMINOPROPYLMETHYL- | 3069-29-2 | 25 | 75 | 50 | 50 | | |
| DIMETHOXYSILANE | | | | | | | |
| Trialkoxy functional silanes | | | | | | | |
| AMINOPROPYLTRIETHOXYSILANE | 919-30-2 | | | | 20 | | |
| Monoalkoxy functional silanes | | | | | | | |
| TRIMETHYLETHOXYSILANE | 1825-62-3 | 10 | 10 | 10 | 10 | 10 | 10 |
| Other materials | | | | | | | |
| Triethylamine (catalyst) | 121-44-8 | | | | | | |
| Cyclohexanone | 108-94-1 | | | | | 50 | 50 |
| DBTL (catalyst) | 77-58-7 | 1 | 1 | 1 | 1 | 1 | 1 |
| Water | 7732-18-5 | 2 | 2 | 2 | 2 | 2 | 2 |
| Polysiloxane (Dow Corning 3074 Intermediate*) | — | 100 | 100 | 100 | 100 | 100 | 100 |

*Dow Corning 3074 is a silicone intermediate, 67% crosslinked. Silica (SiO2) is rated as 100% crosslinked and dimethyl silicone fluids [(CH3)2SiO]x are 50% crosslinked.

Before reproducing the results, use appropriate personal protection, read the health and safety datasheets. A special note is that the condensation reactions will give methanol and ethanol fumes which are both toxic and flammable.

For each example given in Table 1:

Charge the dialkoxy functional silane into a reflux boiler while stirring.

Add the Trialkoxy functional silane.

Add the polysiloxane and catalyst.

Add the water, rise temperature to 80° C., while stirring.

Keep at this temperature until sufficient degree of alkoxy crosslinking is achieved, or until no increase of viscosity can be seen.

Add the monoalkoxyfunctional silane, and stir for 60 minutes.

Add the cyclohexanone, and stir for 60 minutes (only recipe 5 and 6).

If a reduced solvent content is desired, the reflux can be removed, and the volatile components evaporated. AMINOPROPYLMETHYLDIETHOXYSILANE, CAS: 3179-76-8, available as a commercial product: Dynasylan® 1505 from Evonik Degussa, Untere Kanalstrasse 3, 79618 Rheinfelden, Germany.

AMINOETHYLAMINOPROPYLMETHYLDIMETHOXYSILANE, CAS: 3069-29-2, available as a commercial product: Dynasylan® 1411 from Evonik Degussa, Untere Kanalstrasse 3, 79618 Rheinfelden, Germany.

AMINOPROPYLTRIETHOXYSILANE, CAS: 919-30-2, available as a commercial product: Dynasylan® AMEO from Evonik Degussa, Untere Kanalstrasse 3, 79618 Rheinfelden, Germany.

TRIMETHYLETHOXYSILANE, CAS: 1825-62-3, available as a commercial product: SILANE M3-ETHOXY from Wacker Chemie AG, Werk Burghausen, Johannes-Hess-Straβe 24, 84489 Burghausen, Germany.

Cyclohexanone, CAS: 108-94-1, available as a commercial product: Triethylamine from SIGMA-ALDRICH Chemie GmbH, Eschenstrasse 5, D-82024 Taufkirchen, Germany. DBTL, CAS: 77-58-7, available as a commercial product: Tegokat® 218 from Goldschmidt Industrial Chemical Corporation, 941 Robinson Highway, McDonald, Pa. 15057-2213, United States.

Water, CAS: 7732-18-5.

Polysiloxane (DOW CORNING® 3074 INTERMEDIATE), CAS: N/A (polymer), available as a commercial product: DOW CORNING® 3074 INTERMEDIATE from Dow Corning Corporation, Corporate Center, PO box 994, MIDLAND MI 48686-0994, United States.

TABLE 2
Epoxy functional polysiloxanes

| | | 7 | 8 | 9 | 10 |
|---|---|---|---|---|---|
| | CAS N. | [g] | [g] | [g] | [g] |
| Dialkoxy functional silanes | | | | | |
| GLYCIDOXYPROPYLMETHYL- | 2897-60-1 | 25 | 75 | 50 | 50 |
| DIETHOXYSILANE | | | | | |
| Trialkoxy functional silanes | | | | | |
| GLYCIDOXYPROPYLTRIMETHOXYSILANE | 2530-83-8 | | | | 20 |
| Monoalkoxy functional silanes | | | | | |
| TRIMETHYLETHOXYSILANE | 1825-62-3 | 10 | 10 | 10 | 10 |
| Other materials | | | | | |
| Triethylamine (catalyst) | 121-44-8 | 1 | 1 | 1 | 1 |
| DBTL | 77-58-7 | 1 | 1 | 1 | 1 |
| Water | 7732-18-5 | 2 | 2 | 2 | 2 |
| Polysiloxane (Dow Corning 3074 Intermediate*) | — | 100 | 100 | 100 | 100 |

*Dow Corning 3074 is an alkoxyfunctional silicone intermediate, 67% crosslinked. Silica (SiO2) is rated as 100% crosslinked and dimethyl silicone fluids [(CH3)2SiO]x are 50% crosslinked.

Before reproducing the results, use appropriate personal protection, read the health and safety datasheets. A special note is that the condensation reactions will give methanol and ethanol fumes which are both toxic and flammable.

For each example given in Table 2:

Charge the dialkoxy functional silane into a reflux boiler while stirring.

Add the Trialkoxy functional silane.

Add the polysiloxane and catalysts.

Add the water, rise temperature to 80° C., while stirring.

Keep at this temperature until sufficient degree of alkoxy crosslinking is achieved, or until no increase of viscosity can be seen.

Add the monoalkoxyfunctional silane, and stir for 60 minutes.

If a reduced solvent content is desired, the reflux can be removed, and the volatile components evaporated.

GLYCIDOXYPROPYLMETHYLDIETHOXYSILANE, CAS: 2897-60-1, available as a commercial product: GENIOSIL® GF 84 from Wacker Chemie AG, Werk Burghausen, Johannes-Hess-Straβe 24, 84489 Burghausen, Germany.

GLYCIDOXYPROPYLTRIMETHOXYSILANE, CAS: 2530-83-8, available as a is commercial product: Dynasylan® GLYMO from Evonik Degussa, Untere Kanalstrasse 3,

### 79618 Rheinfelden, Germany.

TRIMETHYLETHOXYSILANE, CAS: 1825-62-3, available as a commercial product: SILANE M3-ETHOXY from Wacker Chemie AG, Werk Burghausen, Johannes-Hess-Straβe 24, 84489 Burghausen, Germany.

Triethylamine, CAS: 121-44-8, available as a commercial product: Triethylamine from Fluka Chemie GmbH/Sigma-Aldrich Chemie GmbH, Riedstraβe 2, D-89555 Steinheim, Germany.

DBTL, CAS: 77-58-7, available as a commercial product: Tegokat® 218 from Goldschmidt Industrial Chemical Corporation, 941 Robinson Highway, McDonald, Pa. 15057-2213, United States.

Water, CAS: 7732-18-5.

Polysiloxane (DOW CORNING® 3074 INTERMEDIATE), CAS: N/A (polymer), available as a commercial product: DOW CORNING® 3074 INTERMEDIATE from Dow Corning Corporation, Corporate Center, PO box 994, MIDLAND MI 48686-0994, United States.

TABLE 3
Mercapto functional polysiloxanes

| | | 11 | 12 | 13 | 14 |
|---|---|---|---|---|---|
| | CAS N. | [g] | [g] | [g] | [g] |
| Dialkoxy functional silanes | | | | | |
| MERCAPTOPROPYLMETHYL- | 31001-77-1 | 25 | 75 | 50 | 50 |
| DIMETHOXYSILANE | | | | | |
| Trialkoxy functional silanes | | | | | |
| MERCAPTOPROPYLTRIMETHOXYSILANE | 4420-74-0 | | | | 20 |
| Monoalkoxy functional silanes | | | | | |
| TRIMETHYLETHOXYSILANE | 1825-62-3 | 10 | 10 | 10 | 10 |
| WACKER-SILANE M3-ETHOXY | | | | | |
| Other materials | | | | | |
| Triethylamine (catalyst) | 121-44-8 | 1 | 1 | 1 | 1 |
| DBTL | 77-58-7 | 1 | 1 | 1 | 1 |
| Water | 7732-18-5 | 2 | 2 | 2 | 2 |
| Polysiloxane (Dow Corning 3074 | — | 100 | 100 | 100 | 100 |
| Intermediate*) | | | | | |

*Dow Corning 3074 is an alkoxyfunctional silicone intermediate, 67% crosslinked. Silica (SiO2) is rated as 100% crosslinked and dimethyl silicone fluids [(CH3)2SiO]x are 50% crosslinked.

Before reproducing the results, use appropriate personal protection, read the health and safety datasheets. A special note is that the condensation reactions will give methanol and ethanol fumes which are both toxic and flammable.

For each example given in Table 3:

Charge the dialkoxy functional silane into a reflux boiler while stirring.

Add the Trialkoxy functional silane.

Add the polysiloxane and catalysts.

Add the water, rise temperature to 80° C., while stirring.

Keep at this temperature until sufficient degree of alkoxy crosslinking is achieved, or until no increase of viscosity can be seen.

Add the monoalkoxyfunctional silane, and stir for 60 minutes.

If a reduced solvent content is desired, the reflux can be removed, and the volatile components evaporated.

MERCAPTOPROPYLMETHYLDIMETHOXYSILANE, CAS: 31001-77-1, available as a commercial product: SiSiB® PC2320 from Power Chemical Corporation, #117, Gunghua Road, Nanjing 210007, P.R. China

MERCAPTOPROPYLTRIMETHOXYSILANE, CAS: 4420-74-0, available as a commercial product: SiSiB® PC2300 from Power Chemical Corporation, #117, Gunghua Road, Nanjing 210007, P.R. China

TRIMETHYLETHOXYSILANE, CAS: 1825-62-3, available as a commercial product: SILANE M3-ETHOXY from Wacker Chemie AG, Werk Burghausen, Johannes-Hess-Straβe 24, 84489 Burghausen, Germany.

Triethylamine, CAS: 121-44-8, available as a commercial product: Triethylamine from Fluka Chemie GmbH/Sigma-Aldrich Chemie GmbH, Riedstraβe 2, D-89555 Steinheim, is Germany.

DBTL, CAS: 77-58-7, available as a commercial product: Tegokat® 218 from Goldschmidt Industrial Chemical Corporation, 941 Robinson Highway, McDonald, Pa. 15057-2213, United States.

Water, CAS: 7732-18-5.

Polysiloxane (DOW CORNING® 3074 INTERMEDIATE), CAS: N/A (polymer), available as a commercial product: DOW CORNING® 3074 INTERMEDIATE from Dow Corning Corporation, Corporate Center, PO box 994, MIDLAND MI 48686-0994, United States.

TABLE 4
Vinyl functional polysiloxanes

| | | 15 | 16 | 17 | 18 |
|---|---|---|---|---|---|
| | CAS N. | [g] | [g] | [g] | [g] |
| Dialkoxy functional silanes | | | | | |
| VINYLMETHYLDIMETHOXYSILANE | 16753-62-1 | 25 | 75 | 50 | 50 |
| Trialkoxy functional silanes | | | | | |
| VINYLTRIMETHOXYSILANE | 2768-02-7 | | | | 20 |
| Monoalkoxy functional silanes | | | | | |
| TRIMETHYLETHOXYSILANE | 1825-62-3 | 10 | 10 | 10 | 10 |
| Other materials | | | | | |
| Triethylamine (catalyst) | 121-44-8 | 1 | 1 | 1 | 1 |
| DBTL | 77-58-7 | 1 | 1 | 1 | 1 |
| Water | 7732-18-5 | 2 | 2 | 2 | 2 |
| Polysiloxane (Dow Corning 3074 | — | 100 | 100 | 100 | 100 |
| Intermediate*) | | | | | |

*Dow Corning 3074 is an alkoxyfunctional silicone intermediate, 67% crosslinked. Silica (SiO2) is rated as 100% crosslinked and dimethyl silicone fluids [(CH3)2SiO]x are 50% crosslinked.

Before reproducing the results, use appropriate personal protection, read the health and safety datasheets. A special note is that the condensation reactions will give methanol and ethanol fumes which are both toxic and flammable.

For each example given in Table 4:

Charge the dialkoxy functional silane into a reflux boiler while stirring.

Add the Trialkoxy functional silane.

Add the polysiloxane and catalysts.

Add the water, rise temperature to 80° C., while stirring.

Keep at this temperature until sufficient degree of alkoxy crosslinking is achieved, or until no increase of viscosity can be seen.

Add the monoalkoxyfunctional silane, and stir for 60 minutes.

If a reduced solvent content is desired, the reflux can be removed, and the volatile components evaporated.

DIMETHYLDIETHOXYSILANE, CAS: 16753-62-1, available as a commercial product: GENIOSIL® XL 12 from Wacker Chemie AG, Werk Burghausen, Johannes-Hess-Straβe 24, 84489 Burghausen, Germany.

16753-62-1

VINYLTRIMETHOXYSILANE, CAS: 2768-02-7, available as a commercial product: GENIOSIL® XL 10 from Wacker Chemie AG, Werk Burghausen, Johannes-Hess-Straβe 24, 84489 Burghausen, Germany.

TRIMETHYLETHOXYSILANE, CAS: 1825-62-3, available as a commercial product: SILANE M3-ETHOXY from Wacker Chemie AG, Werk Burghausen, Johannes-Hess-Straβe 24, 84489 Burghausen, Germany.

Triethylamine, CAS: 121-44-8, available as a commercial product: Triethylamine from Fluka Chemie GmbH/Sigma-Aldrich Chemie GmbH, Riedstraβe 2, D-89555 Steinheim, Germany.

DBTL, CAS: 77-58-7, available as a commercial product: Tegokat® 218 from Goldschmidt Industrial Chemical Corporation, 941 Robinson Highway, McDonald, Pa. 15057-2213, United States.

Water, CAS: 7732-18-5.

Polysiloxane (DOW CORNING® 3074 INTERMEDIATE), CAS: N/A (polymer), available as a commercial product: DOW CORNING® 3074 INTERMEDIATE from Dow Corning Corporation, Corporate Center, PO box 994, MIDLAND MI 48686-0994, United States.

TABLE 5
Methacrylate functional polysiloxanes prepared according to the present
invention

| | | 19 | 20 | 21 | 22 |
|---|---|---|---|---|---|
| | CAS N. | [g] | [g] | [g] | [g] |
| Dialkoxy functional silanes | | | | | |
| METHACRYLOXYMETHYLMETHYL- | 121177-93-3 | 25 | 75 | 50 | 50 |
| DIMETHOXYSILANE | | | | | |
| Trialkoxy functional silanes | | | | | |
| METHACRYLOXYPROPYL- | 2530-85-0 | | | | 20 |
| TRIMETHOXYSILANE | | | | | |
| Monoalkoxy functional silanes | | | | | |
| TRIMETHYLETHOXYSILANE | 1825-62-3 | 10 | 10 | 10 | 10 |
| Other materials | | | | | |
| Triethylamine (catalyst) | 121-44-8 | 1 | 1 | 1 | 1 |
| DBTL | 77-58-7 | 1 | 1 | 1 | 1 |
| Water | 7732-18-5 | 2 | 2 | 2 | 2 |
| Polysiloxane (Dow Corning 3074 | — | 100 | 100 | 100 | 100 |
| Intermediate*) | | | | | |

*Dow Corning 3074 is an alkoxyfunctional silicone intermediate, 67% crosslinked. Silica (SiO2) is rated as 100% crosslinked and dimethyl silicone fluids [(CH3)2SiO]x are 50% crosslinked.

Before reproducing the results, use appropriate personal protection, read the health and safety datasheets. A special note is that the condensation reactions will give methanol and ethanol fumes which are both toxic and flammable.

For each example given in Table 5: Charge the dialkoxy functional silane into a reflux boiler while stirring.

Add the Trialkoxy functional silane.

Add the polysiloxane and catalysts.

Add the water, rise temperature to 80° C., while stirring.

Keep at this temperature until sufficient degree of alkoxy crosslinking is achieved, or until no increase of viscosity can be seen.

Add the monoalkoxyfunctional silane, and stir for 60 minutes.

If a reduced solvent content is desired, the reflux can be removed, and the volatile components evaporated.

METHACRYLOXYMETHYLMETHYLDIMETHOXYSILANE, CAS: 121177-93-3, available as a commercial product: GENIOSIL® XL 32 from Wacker Chemie AG, Werk Burghausen, Johannes-Hess-Straβe 24, 84489 Burghausen, Germany.

METHACRYLOXYPROPYLTRIMETHOXYSILANE, CAS: 2530-85-0, available as a commercial product: GENIOSIL® GF 31 from Wacker Chemie AG, Werk Burghausen, Johannes-Hess-Straβe 24, 84489 Burghausen, Germany.

TRIMETHYLETHOXYSILANE, CAS: 1825-62-3, available as a commercial product: SILANE M3-ETHOXY from Wacker Chemie AG, Werk Burghausen, Johannes-Hess-Straβe 24, 84489 Burghausen, Germany.

Triethylamine, CAS: 121-44-8, available as a commercial product: Triethylamine from Fluka Chemie GmbH/Sigma-Aldrich Chemie GmbH, Riedstraβe 2, D-89555 Steinheim, is Germany.

DBTL, CAS: 77-58-7, available as a commercial product: Tegokat® 218 from Goldschmidt Industrial Chemical Corporation, 941 Robinson Highway, McDonald, Pa. 15057-2213, United States.

Water, CAS: 7732-18-5.

Polysiloxane (DOW CORNING® 3074 INTERMEDIATE), CAS: N/A (polymer), available as a commercial product: DOW CORNING® 3074 INTERMEDIATE from Dow Corning Corporation, Corporate Center, PO box 994, MIDLAND MI 48686-0994, United States.

### Polymeric Properties

TABLE 6
Properties of polymers obtained by example 1-22.

| | Viscosity | Density | Appearance |
|---|---|---|---|
| Example | [cP] | [g/ml] | [visual] |
| 1 | 1200 | 1.1 | Clear, slight yellow color |
| 2 | 70 | 1.1 | Clear, slight yellow color |
| 3 | 180 | 1.1 | Clear, slight yellow color |
| 4 | 100 | 1.1 | Clear, slight yellow color |
| 5 | 430 | 1.1 | Clear, yellow color |
| 6 | 590 | 1.1 | Clear, yellow color |
| 7 | 500 | 1.1 | Clear, slight yellow color |
| 8 | 60 | 1.1 | Clear, slight yellow color |
| 9 | 150 | 1.1 | Clear, slight yellow color |
| 10 | 120 | 1.1 | Clear, slight yellow color |
| 11 | 100 | 1.1 | Hazy, no color |
| 12 | 50 | 1.1 | Slight hazy, no color |
| 13 | 70 | 1.1 | Slight hazy, no color |
| 14 | 80 | 1.1 | Slight hazy, no color |
| 15 | 110 | 1.2 | Clear, no color |
| 16 | 40 | 1.1 | Clear, no color |
| 17 | 60 | 1.1 | Clear, no color |
| 18 | 90 | 1.1 | Clear, no color |
| 19 | 80 | 1.1 | Clear, no color |
| 20 | 50 | 1.1 | Clear, no color |
| 21 | 60 | 1.1 | Clear, no color |
| 22 | 80 | 1.0 | Clear, no color |

Coatings based on the polymers from the examples 1-22

The coatings were made as clear coats without additives or additional solvents.

TABLE 7
Examples to illustrate the properties of coating based on current
invention as a prepolymerized resin.

| | | | | | | | Flexibility |
|---|---|---|---|---|---|---|---|
| | | | | | | | after 24 h in |
| | | Hardener | | | | | 50° C. |
| | | (ratio by | | Surface | Gloss | | Conical |
| Ex. | Polymer | weight) | Appearance | dry, BK. | 60° | Tg | Mandrel, % |
| 23 | 1 | Polymer from | Clear | 3.5 | <100 | ** | 3 |
| | | Example #9 | | | | | |
| | | (1:1) | | | | | |
| 24 | 2 | Polymer from | Clear | 3.3 | <100 | ** | 10 |
| | | Example #9 | | | | | |
| | | (1:1) | | | | | |
| 25 | 3 | Polymer from | Clear | 3.3 | <100 | ** | 6.5 |
| | | Example #9 | | | | | |
| | | (1:1) | | | | | |
| 26 | 4 | Polymer from | Clear | 3.0 | <100 | ** | 8 |
| | | Example #9 | | | | | |
| | | (1:1) | | | | | |
| 27 | 5 | Polymer from | Clear, Yellow | 8.5 | <100 | ** | 12 |
| | | Example #9 | | | | | |
| | | (1:1) | | | | | |
| 28 | 6 | Polymer from | Clear, Yellow | 5.0 | <100 | ** | 10 |
| | | Example #9 | | | | | |
| | | (1:1) | | | | | |
| 29 | 7 | Polymer from | Clear | 4.5 | <100 | ** | 4 |
| | | Example #3 | | | | | |
| | | (1:1) | | | | | |
| 30 | 8 | Polymer from | Clear | 3.0 | <100 | ** | 10 |
| | | Example #3 | | | | | |
| | | (1:1) | | | | | |
| 31 | 9 | Polymer from | Clear | 3.3 | <100 | ** | 6.5 |
| | | Example #3 | | | | | |
| | | (1:1) | | | | | |
| 32 | 10 | Polymer from | Clear | 3.0 | <100 | ** | 7 |
| | | Example #3 | | | | | |
| | | (1:1) | | | | | |
| 33 | 11 | Polymer from | Clear | >12*** | | ** | 10 |
| | | Example #9 | | | | | |
| | | (1:1) | | | | | |
| 34 | 12 | Polymer from | Clear | >12*** | | ** | 10 |
| | | Example #9 | | | | | |
| | | (1:1) | | | | | |
| 35 | 13 | Polymer from | Clear | >12*** | | ** | 10 |
| | | Example #9 | | | | | |
| | | (1:1) | | | | | |
| 36 | 14 | Polymer from | Clear | >12*** | | ** | 10 |
| | | Example #9 | | | | | |
| | | (1:1) | | | | | |
| 37 | 15 | Norpol Peroxide | Clear | >12**** | | ** | 10 |
| | | 11 (100:1)* | | | | | |
| 38 | 16 | Norpol Peroxide | Clear | >12**** | | ** | 10 |
| | | 11 (100:1)* | | | | | |
| 39 | 17 | Norpol Peroxide | Clear | >12**** | | ** | 10 |
| | | 11 (100:1)* | | | | | |
| 40 | 18 | Norpol Peroxide | Clear | >12**** | | ** | 10 |
| | | 11 (100:1)* | | | | | |
| 41 | 19 | Norpol Peroxide | Clear | >12*** | | ** | 10 |
| | | 11 (100:1)* | | | | | |
| 42 | 20 | Norpol Peroxide | Clear | >12*** | | ** | 10 |
| | | 11 (100:1)* | | | | | |
| 43 | 21 | Norpol Peroxide | Clear | >12*** | | ** | 10 |
| | | 11 (100:1)* | | | | | |
| 44 | 22 | Norpol Peroxide | Clear | >12*** | | ** | 10 |
| | | 11 (100:1)* | | | | | |

*Norpol Peroxide 11 is a Methylethylketoneperoxide 40-50% solution, available from Reichold AS, Postboks 2061, 3202 Sandefjord.
** A distinctive Tg could not be determined for the cured films.
***The coatings were cured at 80° C. for 24 h.
****The coatings were cured with UV-light.

### Examples Related to Cold Blend Approach

In the following, the coatings are made from a cold blend approach.

### Two Component “Cold Blend” of Silanes.

TABLE 8
The example recipes with two components are as listed:

| | 45 | 46 | 47 | 48 | 49 | 50 |
|---|---|---|---|---|---|---|
| DOW CORNING ® | 50 | 60 | 70 | 40 | 50 | 60 |
| 3074 INTERMEDIATE | | | | | | |
| SILRES ® REN 50 | 20 | 20 | 20 | 60 | 40 | 20 |
| Dynasylan ® 1411 | | 6.8 | 4.3 | | | 6.5 |
| GENIOSIL ® GF 84 | | | 15.7 | | 22 | 23.5 |
| Dynasylan ® GLYMO | 29 | 23.2 | | 21.7 | | |
| Dynasylan ® AMMO | 11 | | | 8.3 | 8 | |

DOW CORNING ® 3074 INTERMEDIATE is available from Dow Corning Corporation, Corporate Center, PO box 994, MIDLAND MI 48686-0994, United States.
SILRES REN 50 is a solution of a methyl-phenyl containing polysiloxanes in xylene available from Wacker Chemie AG, Werk Burghausen, Johannes-Hess-Straβe 24, 84489 Burghausen, Germany.
Dynasylan ® GLYMO, Dynasylan ® AMMO and Dynasylan ® 1411 are available from Evonik Degussa, Untere Kanalstrasse 3, 79618 Rheinfelden, Germany.
GENIOSIL ® GF 84 is available from Wacker Chemie AG, Werk Burghausen, Johannes-Hess-Straβe 24, 84489 Burghausen, Germany.

TABLE 9
Drying times etc. for recipes with two components are as listed:

| | Drying | Gloss | Elongation by Conical | |
|---|---|---|---|---|
| Ex. | times [h] | [60°] | Mandrel[%] | Tg |
| 45 | 8.5 | 100 | <2 | * |
| 46 | 9 | 95 | 6.5 | * |
| 47 | 13 | 85 | 22 | * |
| 48 | 9.5 | 100 | 7 | * |
| 49 | 7.5 | 80 | 21 | * |
| 50 | 12 | 70 | 20 | * |

* A distinctive Tg could not be determined for the cured films.

### One Component “Cold Blend” of Silanes.

TABLE 10
The example recipes with one component are as listed

| | 51 | 52 | 53 | 54 | 55 | 56 |
|---|---|---|---|---|---|---|
| DOW CORNING ® | 50 | 60 | 70 | 40 | 50 | 60 |
| 3074 INTERMEDIATE | | | | | | |
| SILRES ® REN 50 | 20 | 20 | 20 | 60 | 40 | 20 |
| Dynasylan ® 1411 | | 6.8 | 3.4 | 10 | 10 | 10 |
| Dynasylan ® AMMO | 11 | | 5.5 | 5 | 2.5 | 7.5 |

DOW CORNING ® 3074 INTERMEDIATE available from Dow Corning Corporation, Corporate Center, PO box 994, MIDLAND MI 48686-0994, United States.
SILRES REN 50 is a solution of a methyl-phenyl containing polysiloxanes in xylene available from Wacker Chemie AG, Werk Burghausen, Johannes-Hess-Straβe 24, 84489 Burghausen, Germany.
Dynasylan ® 1505 and Dynasylan ® 1411 are available from Evonik Degussa, Untere Kanalstrasse 3, 79618 Rheinfelden, Germany.

TABLE 11
Drying times etc. for recipes with one component are as listed

| | Drying | Gloss | Elongation by Conical | |
|---|---|---|---|---|
| Ex. | times [h] | [60°] | Mandrel[%]. | Tg |
| 51 | 4 | 90 | <2 | * |
| 52 | 6 | 85 | 6 | * |
| 53 | 5 | 90 | <2 | * |
| 54 | 4 | 90 | 4 | * |
| 55 | 5 | 90 | 5 | * |
| 56 | 3 | 89 | <2 | * |

* A distinctive Tg could not be determined for the cured films.

1. An ambient temperature curable coating composition comprising:
a) a polysiloxane having the formula: 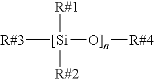
wherein, for each repeating polymer unit,
R#1, R#2 and R#3 are independently selected from the group consisting of alkyl, aryl, reactive glycidoxy groups having up to 20 carbon atoms, and OSi(OR#5)₃ groups,
wherein each R#5 independently has the same meaning as R#1, R#2 or R#3, and R#4 are is either alkyl, aryl or hydrogen, and wherein n is selected so as that the molecular weight of the polysiloxane is in the range of 500 to 2000; and
b) an organo functional silane with two hydrolysable groups having the formula 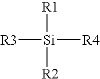
wherein R1 is selected from the group consisting of alkyl, aryl, reactive glycidoxy, amino, mercapto, vinyl, isocyanate or methacrylate groups having up to 20 carbon atoms;
R2 is selected from the group consisting of reactive glycidoxy, amino, mercapto, vinyl, isocyanate or methacrylate groups having up to 20 carbon atoms; and
R3 and R4 are halogen or alkoxy, ketoxime or acetoxy groups having up to six carbon atoms;
wherein the coating composition has a solids content of at least 60% by weight.

2. (canceled)

3. A coating composition according to claim 1, wherein the organofunctional silane is amino functional, and the polysiloxane comprises either reactive epoxy or reactive methacrylate functional groups or a combination thereof.

4. A coating composition according to claim 1, wherein the composition further comprises an additional organic binder.

5. A coating composition according to claim 4, wherein the additional organic binder is reactive and can undergo a reaction with the organofunctional silane, the polysiloxane or both said components.

6-10. (canceled)

11. A decorative coating comprising the composition of claim 1.

12. An antigrafitti coating comprising the composition of claim 1.

13. An antifouling coating comprising the composition of claim 1.

14. A method for protecting a substrate, the method comprising applying to the substrate the composition of claim 1.

15. The method of claim 14, wherein the substrate is steel or metal substrate.

16. The method of claim 15, wherein the composition is applied directly to the substrate or applied as a topcoat on a coated substrate.

17. (canceled)

18. The method of claim 14, wherein the substrate is wood, plastic or concrete.

19. A method for preventing fouling on a surface comprising applying the composition of claim 1 to the surface.

20. A coating composition according to claim 1 wherein said silane is an organofunctional silane with two hydrolysable groups having the formula 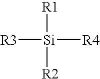
wherein R1 is selected from the group consisting of alkyl, aryl, reactive amino, or methacrylate groups having up to 20 carbon atoms;
R2 is selected from the group consisting of reactive amino or methacrylate groups having up to 20 carbon atoms;
and R3 and R4 are alkoxy groups having up to six carbon atoms.

21. A coating composition according to claim 1 wherein the silane is aminopropylmethyldiethoxysilane, aminoethylaminopropylmethyldimethoxysilane, glycidoxypropylmethyldiethoxysilane, isocyanatomethylmethyldimethoxysilane, mercaptopropylmethyldimethoxysilane, vinyldimethoxymethylsilane, or methacryloxypropylmethyldimethoxysilane.

22. A coating composition according to claim 1 further comprising an organofunctional silane with three hydrolysable groups having the formula 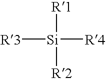
wherein R′1 is independently selected from the group consisting of alkyl, aryl, reactive glycidoxy, amino, mercapto, vinyl, isocyanate or methacrylate groups having up to 20 carbon atoms, R2′, R′3 and R′4 are halogen or alkoxy, ketoxime or acetoxy groups having up to six carbon atoms.

23. A composition as claimed in claim 22 wherein the additional silane is aminopropyltriethoxysilane, aminopropyltrimethoxysilane, glycidoxypropyltrimethoxysilane, isocyanatopropyltrimethoxysilane, mercaptopropyltrimethoxysilane, vinyltrimethoxysilane, or methacryloxypropyltrimethoxysilane.

24. A coating composition according to claim 1 further comprising an organofunctional silane with one hydrolysable group having the formula 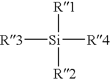
wherein R″1, R″2 and R″3 are independently selected from the group consisting of alkyl, aryl, reactive glycidoxy, amino, mercapto, vinyl, isocyanate or methacrylate groups having up to 20 carbon atoms, R″4 is halogen or alkoxy, ketoxime or acetoxy groups having up to six carbon atoms.

25. A composition according to claim 24 wherein the additional silane is trimethylethoxysilane.

26. A coating composition formed from the full or partial condensation of an ambient temperature curable coating composition as claimed in claim 1 wherein the polysiloxane is free of epoxy groups.

27. A process for forming a cured coating composition comprising mixing
a) a polysiloxane having the formula: 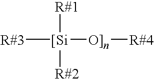
wherein, for each repeating polymer unit,
R#1, R#2 and R#3 are independently selected from the group consisting of alkyl, aryl, reactive glycidoxy groups having up to 20 carbon atoms, and OSi(OR#5)₃ groups, wherein each R#5 independently has the same meaning as R#1, R#2 or R#3, and R#4 are either alkyl, aryl or hydrogen, and
wherein n is selected so as that the molecular weight of the polysiloxane is in the range of 500 to 2000;
and
b) an organofunctional silane with two hydrolysable groups having the formula 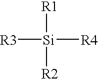
wherein R1 is selected from the group consisting of alkyl, aryl, reactive glycidoxy, reactive amino, mercapto, vinyl, isocyanate or methacrylate groups having up to 20 carbon atoms;
R2 is selected from the group consisting of reactive glycidoxy, reactive amino, mercapto, vinyl, isocyanate or methacrylate groups having up to 20 carbon atoms; and
R3 and R4 are halogen or alkoxy, ketoxime or acetoxy groups having up to six carbon atoms;
to form a composition having a solids content of at least 60% by weight; and
allowing a curing reaction to take place so as to form a full or partially condensed cured coating composition wherein the polysiloxane is free of epoxy groups.
